(19) United States
(12) Patent Application Publication
(10) Pub. No.: US 2018/0273395 A1
(43) Pub. Date: Sep. 27, 2018

(54) PRODUCTION OF PRECIPITATED CALCIUM CARBONATE

(71) Applicant: COATEX, Genay (FR)

(72) Inventor: Christian JACQUEMET, Lyon (FR)

(73) Assignee: COATEX, Genay (FR)

(21) Appl. No.: 15/542,467

(22) PCT Filed: Feb. 24, 2016
(86) PCT No.: PCT/FR2016/050429

§ 371 Date: Jul. 10, 2017

(30) Foreign Application Priority Data
Feb. 27, 2015 (FR) 1551690

(51) Int. Cl. C01F 11/18

(52) U.S. Cl. CPC C01F 11/183; C01P 2004/61; D21H 17/675; C01P 2006/12; C01P 2006/22; C01P 2004/62

(57) ABSTRACT

The present invention relates to the use of at least one cationic polymer in a method for manufacturing a precipitated calcium carbonate aqueous suspension, in which a milk of lime is prepared by mixing water, a calcium oxide containing material, said at least one cationic polymer, optionally at least one slaking additive, said milk of lime being them carbonated to form a precipitated calcium carbonate aqueous suspension.

The present invention relates to the use of a cationic polymer in a method for producing precipitated calcium carbonate, said cationic polymer being optionally used in combination with at least one slaking additive. Thus, the invention relates to a method for producing precipitated calcium carbonate, comprising the use of a cationic polymer, optionally in combination with at least one slaking additive.

### BACKGROUND OF THE INVENTION

Calcium carbonate is one of the most commonly used additives in the paper, paint and plastics industries. While naturally occurring Ground Calcium Carbonate (GCC) is usually used as a mineral filler in many applications, synthetical Precipitated Calcium Carbonate (PCC) may be tailor-made with respect to its morphology and particle size allowing these materials to fulfil other functions.

Scalenohedral Precipitated Calcium Carbonate (S-PCC) notably is used as a mineral filler in combination with cellulosic fibres in wet-end applications.

Commonly known PCC production methods comprising the steps of slaking quicklime with water and subsequently precipitating calcium carbonate by passing carbon dioxide through the resulting calcium hydroxide suspension, produce only PCC slurries with low dry solids content. Therefore, these methods typically comprise a subsequent concentration step in order to obtain a more concentrated PCC slurry, which is of interest for the transport of the PCC slurry. However, such additional concentration steps are energy-consuming and cost-intensive and require an equipment such as a centrifuge, which is expensive and needs high maintenance. Furthermore, mechanical dewatering methods using centrifuges may destroy the structure of the formed PCC, for example in case of clustered scalenohedral PCC.

Methods for preparing PCC in the presence of different additives are described in the literature.

Document U.S. 2011/158890 A1 describes a method to manufacture PCC involving the use of a comb polymer, which reduces the carbonation time of the PCC.

Document WO 2005/000742 A1 is directed to a method for preparing platy PCC comprising the steps of providing a suspension of calcium hydroxide, carbonating said suspension, and adding a polyacrylate to the suspension prior to the completion of the carbonation to precipitate platy calcium carbonate.

Document EP 0 281 134 relates to a cationic pigment dispersion which is suitable in particular for preparing paper coating compositions and contains (a) a pigment compound which is composed of ground and/or precipitated calcium carbonate, kaolin, calcined kaolin, titanium dioxide, zinc oxide, satin while, aluminum hydrosilicate or mixtures thereof, (b) a cationised polymer which surrounds the pigment particles as a protective colloid and has been obtained from hydrophilic polyacrylates or polymethacrylates, degraded starches or degraded modified starches, methylcelluloses, hydroxymethylcelluloses, carboxymethylcelluloses, degraded alginates, proteins and/or polyvinyl alcohol and which brings the Zeta potential of the dispersion containing the enrobed pigment particles to the isoelectric point or into the cationic range, and optionally (c) a cationic polymer or a quaternary ammonium compound as a dispersing agent for the colloid-enrobed and cationised pigment particles.

Document U.S. 2006/0137574 A1 relates to a pigment composition, comprising at least one calcium carbonate chosen from rhombohedral calcium carbonate and ground calcium carbonate, at least one anionic dispersing agent present in an amount sufficient to overdisperse the at least one calcium carbonate and at least one cationic polymer.

Document WO 06/109171 A1 relates to PCC pigments, to be used in paper coating formulations to manufacture coated high-quality matt papers, in particular for inkjet applications. Method for preparing these PCC pigments, using a reduced flow rate of a carbon dioxide-containing gas in the PCC carbonation step, produces stable and porous agglomerates of PCC having unique properties and structure, this step being followed by a concentration step to increase the dry solids content, said concentration being conducted without the use of a dispersing aid agent or with a cationic dispersing aid agent.

Document U.S. 2005/0221026 A1 relates to a thermal ink jet recording paper, incorporating dewatered and ground Precipitated Calcium Carbonate (PCC). Precipitated calcium carbonate is dewatered and ground in the presence of an amphoteric or anionic dispersing agent to produce a high dry solids content PCC composition.

Unpublished patent application EP 14166751.9 filed in the name of present applicants relates to the use of a combination of at least one water-soluble polymer and at least one slaking additive in a method for producing an aqueous suspension of precipitated calcium carbonate.

Document FR 2 934 992 relates to the use, for the manufacture of a precipitated mineral matter, of at least one particular copolymer. This copolymer would reduce the carbonation time and thus increase the yield of the method of manufacture.

Document WO 2007/067146 A1 discloses a method for preparing PCC using starch or carboxymethylcellulose during the calcium hydroxide carbonation.

Document WO 2010/093092 A1 describes a method of CO₂ capture by the precipitation of calcium carbonate in the presence of an amine polymer.

### SUMMARY

An object of the present invention is to provide a solution for the production of PCC slurries, for example with high dry solids content, without an additional thermal or mechanical concentration step.

Another object of the present invention is to provide a solution for the production of high dry solids content PCC slurries with easily manageable viscosities, that is to say a solution making it possible to increase the dry solids content of PCC slurries, while presenting the increase of the slurries' viscosity.

If is also desirable that said solution does not affect the kinetics of the carbonation step in a negative way and/or does not impair the crystallography structure of the PCC.

Another object of the present invention is to provide a solution for preparing PCC slurries with cationic surface charges, even at alkaline pH.

Another object of the present invention is to provide a solution for preparing PCC slurries to be directly used as a mineral filler in a paper-making method.

The present invention relates to the use of at least one cationic polymer in a method for producing an aqueous suspension of precipitated calcium carbonate, said method comprising the steps consisting in:
i) preparing a milk of lime by mixing water, a calcium oxide containing material and said at least one cationic polymer, the calcium oxide containing material and water are mixed in a weight ratio from 1:1 to 1:6 and
ii) carbonating the milk of lime obtained from step i) to form an aqueous suspension of precipitated calcium carbonate.

Thus, the invention relates to a method for producing precipitated calcium carbonate, comprising the use of a cationic polymer, optionally in combination with at least one slaking additive, said method comprising the steps consisting in:
i) preparing a milk of lime by mixing water, a calcium oxide containing material and said at least one cationic polymer, the calcium oxide containing material and water are mixed in a weight ratio from 1:1 to 1:6 and
ii) carbonating the milk of lime obtained from step i) to form an aqueous suspension of precipitated calcium carbonate.

The product comprising the precipitated calcium carbonate obtained with the use of a cationic polymer according to the present invention may be a paper, a paper product, an ink, a paint, a coating, a plastic, a polymer composition, an adhesive, a building product, a foodstuff, an agricultural product, a cosmetic product or a pharmaceutical product.

The present invention also relates to the use of a combination of at least one cationic polymer and at least one slaking additive in a method for producing an aqueous suspension of precipitated calcium carbonate.

### DETAILED DESCRIPTION

It should be understood that for the purposes of the present invention, the following terms have the following meaning:

A “calcium oxide containing material”, in the meaning of the present invention, may be a mineral or a synthetic material with a content of calcium oxide of at least 50 wt.-%, preferably 75 wt.-%, more preferably 90 wt.-% and most preferably 9.5 wt.-% relative to the total weight of the calcium oxide containing material. For the purposes of the present invention, a “mineral material” is a solid substance with a definite inorganic chemical composition and characteristic crystalline and/or amorphous structure.

“Ground Calcium Carbonate” (GCC), in the meaning of the present invention, is a calcium carbonate obtained from natural sources, such as limestone, marble or chalk, and subjected to a wet and/or dry treatment such as grinding, screening and/or splitting, for example by means of a cyclone or sorter.

Throughout the present document, the “particle size” of precipitated calcium carbonate or other particulate materials is described by its particle size distribution. The value dₓ represents the diameter for which x% by weight of the particles have diameters less than dₓ. This means that the d₂₀ value is the particle size at which 20 wt.-% of all particles have diameters less than the d value, and the d₉₈ value is the particle size at which 98 wt.-% of all particles have diameters less than the d value. The d₉₈ value is also designated as “top cut”. The d₅₀ value is thus the weight median particle size, i.e. 50 wt.-% of all particles have diameters less than or more than this particle size. For the purposes of the present invention, the particle size is indicated as weight median particle size d₅₀ unless indicated otherwise. For determining the weight median particle size d₅₀ value or the top cut particle size d₉₀ value, a Sedigraph 5100 or 5120 device from the company Micromeritics, USA, may be used.

“Precipitated Calcium Carbonate” (PCC), in the meaning of the present invention, is a synthetic material, generally obtained by precipitation following the reaction of carbon dioxide and calcium hydroxide (hydrated lime) in an aqueous environment or by precipitation of a calcium and a carbonate source in water. Additionally, precipitated calcium carbonate may also be the product making it possible to introduce calcium and carbonate salts, calcium chloride and sodium carbonate, for example, in an aqueous environment. PCC may be in the vaterite, calcite or aragonite form. PCCs are described, for example, in documents EP 2 447 213 A1, EP 2 524 898 A1, EP 2 371 766 A1.

For the purposes of the present invention, the “dry solids content” of a liquid composition is a measure of the amount of material remaining after all the solvents or water have been evaporated.

The “cationic polymer” used in the method of producing an aqueous suspension of precipitated calcium carbonate, in the meaning of the present invention, is defined as a polymer or a copolymer with at least monomer units with a net positive charge and making it possible to produce a PCC slurry with a Zeta potential greater than 0 mV, for example a Zeta potential of between 0 mV and 50 mV. According to one embodiment, the cationic polymer used in the present invention consists of monomer units with a quaternary amine, for example at least 50 mol.-% of monomer units with a quaternary amine.

With reference to the “cationic polymer” used in the method of the present invention, the term “specific viscosity” ηₓₚ is defined as the difference of the relative viscosity as measured at a determined temperature minus 1.

A “BET Specific Surface Area” (SSA), in the meaning of the present invention, is defined as the surface area of the precipitated calcium carbonate particles divided by the mass of PCC particles. As used herein, the specific surface area is measured by N₂ adsorption using the BET isotherm (ISO 9277:1995) and is indicated in m²/g.

In the meaning of the present invention, “stable in an aqueous suspension with a pH of 12 and a temperature of 95° C.” means that the polymer maintains its physical properties and chemical structure when added to an aqueous suspension with a pH of 12 and a temperature of 95° C. For example, the polymer maintains its dispersing qualities and is not depolymerized or degraded under said conditions.

For the purposes of the present invention, the term “viscosity” or “Brookfield viscosity” refers to Brookfield viscosity. The Brookfield viscosity is measured by means of a Brookfield (Type RVT) viscometer at 25° C.±1° C. at 100 rpm using an appropriate spindle and is indicated in mPa·s.

For the purposes of the present application, “water-soluble” materials are defined as materials which, when mixed with deionised water and filtered on a filter with a 0.2 μm pore size at 20° C. to recover the liquid filtrate, provide a mass of less than or equal to 0.1 g of recovered solid material after evaporation between 95° C. and 100° C. of 100 g of said liquid filtrate. “Water-soluble” materials are defined as materials leading to a mass of greater than 0.1 g of recovered solid material after evaporation between 95° C. and 100° C. of 100 g of said liquid filtrate.

A “suspension” or “slurry”, in the meaning of the present invention, comprises insoluble solids and water, and optionally other additives, and usually contains large amounts of solids and, thus, is more viscous and may be of higher density than the liquid from which it is formed.

Unless specified otherwise, the term “drying” refers to a method according to which at least a portion of water is removed from a material to be dried such that a constant weight of the obtained “dry” material at 120° C. is reached. Moreover, a “dry” material may be further defined by its total moisture content which, unless specified otherwise, is less than or equal to 1.0 wt.-%, preferably less than or equal to 0.5 wt.-%, more preferably less than or equal to 0.2 wt.-% and most preferably between 0.03 wt.-% and 0.07 wt.-% relative to the total weight of the dry material.

The “total moisture content” of a material refers to the percentage of moisture (i.e. water) which may be desorbed from a sample upon heating to 220° C.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Where an indefinite or definite article is used when referring to a singular noun, for example “a”, “an” or “the”, this includes a plural of that noun unless something else is specifically stated.

Terms like “obtainable” of “definable” and “obtained” or “defined” are used interchangeably. For example, this means that, unless the context clearly dictates otherwise, the term “obtained” does not indicate, for example, that an embodiment must be obtained, for example, by the sequence of steps following the term “obtained” even though such a limited understanding is always included by the terms “obtained” or “defined” as a preferred embodiment.

The present invention relates to the use of a cationic polymer in a method for producing Precipitated Calcium Carbonate (PCC).

The method for producing an aqueous suspension of PCC comprises the steps consisting in (i) preparing a milk of lime by mixing water, the calcium oxide containing material, the at least one cationic polymer and optionally the at least one slaking additive and (ii) carbonating the milk of lime obtained from step (i) to form an aqueous suspension of precipitated calcium carbonate.

The at least one cationic polymer at least consists of monomer units with a net positive charge for example monomer units with a quaternary amine, and makes it possible to produce a PCC slurry with a Zeta potential greater than 0 mV, for example a Zeta potential of between 0 mV and 50 mV. According to one embodiment, the cationic polymer used in the present invention consists of monomer units with a quatternary amine, for example at least 50 mol.-% of monomer units with a quaternary amine.

The at least one slaking additive may be chosen from the group consisting of organic acids, organic acid salts, sugar alcohols, monosaccharides, disaccharides, polysaccharides, gluconates, phosphonates, lignosulfonates and mixtures thereof.

In method step (i), the calcium oxide containing material and water may be mixed in a weight ratio from 1:2.5 to 1:6, for example from 1:2.5 to 1:4.

The use according to the invention of a cationic polymer in the method for producing PCC, in particular S-PCC, is advantageous for wet-end applications. Indeed, the cationic polymer brings cationic charges to the PCC slurries, which in combination with anionic cellulosic fibres of the paper pulp improve the mineral filler retention.

The details and preferred embodiments of the use according to the invention will be set out in more details hereinafter.

Calcium Oxide Containing Material

In step i) of the method for producing an aqueous suspension of precipitated calcium carbonate, a calcium oxide containing material is provided.

Said calcium oxide containing material may be obtained by calcining a calcium carbonate containing material. Calcination is a thermal treatment method applied to calcium carbonate containing material in order to bring about a thermal decomposition resulting in the formation of calcium oxide and gaseous carbon dioxide. Calcium carbonate containing materials which may be used in such a calcination method are those chosen from the group comprising precipitated calcium carbonates, natural calcium carbonate containing minerals such as marble, limestone and chalk, and mixed alkaline earth carbonate minerals comprising calcium carbonate such as dolomite or calcium carbonate rich fractions from other sources. It is also possible to subject a calcium carbonate containing waste material to a calcination method in order to obtain a calcium oxide containing material.

Calcium carbonate decomposes at about 1,000° C. to calcium oxide (commonly known as quicklime). The calcination step may be carried out under conditions and using equipment well-known to the person skilled in the art. Generally, calcination may be carried out in furnaces or reactors (sometimes referred to as kilns) of various designs including shaft furnaces, rotary kilns, multiple hearth furnaces and fluidized bed reactors. The end of the calcination reaction may be determined, for example, by monitoring the density change, the residual carbonate content, for example by X-ray diffraction, or the slaking reactivity by common methods.

According to one embodiment of the present invention, the calcium oxide containing material is obtained by calcining a calcium carbonate containing material, preferably chosen from the group consisting of precipitated calcium carbonate, natural calcium carbonate minerals such as marble, limestone and chalk, mixed alkaline earth carbonate minerals comprising calcium carbonate such as dolomite and mixtures thereof.

For reasons of efficiency, it is preferred that the calcium oxide containing material has a minimum calcium oxide content of at least 75 wt.-%, preferably at least 90 wt.-% and most preferably 95 wt.-% relative to the total weight of the calcium oxide containing material. According to one embodiment, the calcium oxide containing material consists of calcium oxide.

The calcium oxide containing material may consist of only one type of calcium oxide containing material. Alternatively, the calcium oxide containing material may consist of a mixture of at least two types of calcium oxide containing materials.

The calcium oxide containing material may be used in the method of the invention in its original form, i.e. as a raw material, for example, in form of smaller and bigger chunks. Alternatively, the calcium oxide containing material may be ground before use. According to one embodiment of the present invention, the calcium carbonate containing material is in forms of particles with a weight median particle size d₅₀ from 0.1 μm to 1,000 μm and preferably from 1 μm to 500 μm.

Cationic Polymer

The present invention relates to the use of at least one cationic polymer in a method for preparing PCC, more precisely in the step of preparing a milk of lime which is to be carbonated thereafter. The cationic polymer is defined in the context of the present invention as having at least monomer units with a net positive charge, for example monomer units with a quaternary amine. In addition, said polymer allows the production of a PCC slurry with a Zeta potential greater than 0 mV, for example a Zeta potential of between 0 mV and 50 mV.

According to one embodiment, the cationic polymer used in the present invention consists of at least monomer units with a quaternary amine, for example at least 50 mol.-% of monomer units with a quaternary amine.

According to one aspect of the present invention, the cationic polymer may be a polymeric amine, such as a polymer of quaternary amines or a polymer of amines that may be converted to quaternary amines or combinations thereof.

The cationic polymer may also contain at least two different cationic monomers or contain a cationic monomer and other non-ionic or anionic monomers.

Suitable monomers of the cationic polymer comprise one or more monomers chosen from water-soluble polyolefins containing quaternary ammonium groups which may be in the polymer chain, for example, epichlorohydrin/dimethylamine copolymers (EPI/DMA), alkyl or dialkyldiallylammonium halides, such as dimethyldiallyl ammonium chloride (DMDAC), diethyldiallyl ammonium chloride (DEDAC), dimethyldiallyl ammonium bromide (DMDAB) and diethyldiallyl ammonium bromide (DEDAB), methylacryloyl-oxyethyltrimethyl ammonium chloride (METAC), acryloyl-oxyethyltrimethyl ammonium chloride (AETAC). methacryloyl-oxyethyltrimethyl ammonium methosulfate (METAMS), acryloyl-oxyethyltrimethyl ammonium methosulfate (AETAMS), methacrylamido-propyltrimethyl ammonium chloride (MAPTAC) or acrylamido-propyltrimethyl ammonium chloride (APTAC).

Other additional exemplary monomers comprise dimethylaminoethyl acrylate, dimethylaminoethyl methacrylate and dimethylaminopropylmethacrylamide. Exemplary polymers also comprise products of polymerisation of any of the above listed cationic monomers with non-ionic monomers such as acrylamide. methacrylamide or N,N-dimethylacrylamide.

Exemplary cationic polymers comprise poly(diallyldimethylammonium chloride) (pDADMAC), poly(2-(trimethylamino)ethyl methacrylate) (pMADQUAT), copolymers of quaternary dimethylaminoethyl acrylate, copolymers of quaternary dimethylaminoethyl methacrylate and copolymers of epichlorohydrin/dimethylamine (EPI/DMA).

Other cationic polymers comprise condensates of formaldehyde with melamine, urea or cyanoguanidine. The cationic polymers useful in the present invention also comprise copolymers of the aforementioned cationic monomers with non-ionic monomers, such as acrylamide, methacrylamide, vinyl acetate, vinyl alcohol, N-methylolacrylamide or diacetone acrylamide, and/or anionic monomers, such as acrylic acid, methacrylic acid, AMPS or maleic acid.

Such copolymers are herein so-called “cationic” since part or their monomer units present a net positive charge, for example at least 40 mol.-% or at least 50 mol.-%. According to one embodiment, the overall net charge of these polymers is positive.

According to one aspect of the present invention, the at least one cationic polymer is a poly(diallyldimethylammonium chloride) (pDADMAC) or a poly(2-(trimethylamino)ethyl methacrylate) (pMADQUAT).

According to another aspect of the present invention, the at least one cationic polymer contains monomers with at least one quaternary ammonium group chosen from the group consisting of methylacryloyl-oxyethyltrimethyl ammonium chloride (METAC), acryloyl-oxyethyltrimethyl ammonium chloride (AETAC), methacrylamido-propyltrimethyl ammonium chloride (MAPTAC), acrylamido-propyltrimethyl ammonium chloride (APTAC) and 2-methacryloxyethyltrimethyl ammonium chloride (MADQUAT).

According to another aspect of the invention, the at least one cationic polymer contains monomers of acrylic acid, methacrylic acid, maleic acid, alkyl acrylate, alkyl methacrylate and acrylamide or methacrylamide with alkyl substituted or not.

According to another aspect of the present invention, the at least one cationic polymer consists exclusively of monomers with at least one quaternary ammonium group chosen from the group consisting of methylacryloyl-oxyethyltrimethyl ammonium chloride (METAC), acryloyl-oxyethyltrimethyl ammonium chloride (AETAC), methacrylamido-propyltrimethyl ammonium chloride (MAPTAC), acrylamido-propyltrimethyl ammonium chloride (APTAC) and 2-methacryloxyethyltrimethyl ammonium chloride (MADQUAT).

According to one aspect of the present invention, the at least one cationic polymer may have a weight average molecular weight (Mw) ranging from about 1,000 g/mol to about 5,000,000 g/mol, as determined by Size Exclusion Chromatography (SEC). According to another aspect of the present invention, the at least one cationic polymer may have a molecular weight of at least about 1,000 g/mol, such as a molecular weight of at least about 2,000 g/mol, of at least about 5,000 g/mol, of at least about 10,000 g/mol, of at least about 25,000 g/mol, of at least about 50,000 g/mol, of at least about 100,000 g/mol, of at least about 250,000 g/mol, of at least about 500,000 g/mol or of at least about 1,000,000 g/mol. Physical mixtures of cationic polymers containing different cationic moieties or mixtures of cationic polymers having different average molecular weights and distributions are also considered.

The specific viscosity of the at least one cationic polymer may also reflect its weight average molecular weight. According to one aspect of the present invention, the specific viscosity of the at least one cationic polymer varies between 1 and 20, for example between 1.5 and 10.

According to one embodiment of the present invention, the cationic polymer gives a Zeta potential higher than 0 mV to the aqueous suspensions of PCC produced.

According to another embodiment, the aqueous suspensions of PCC obtained with the use of the cationic polymer are characterized in that they have a Zeta potential higher than 0 mV, for example between 0 mV and +50 mV, for example between 0 mV and +40 mV. According to one embodiment, the at least one cationic polymer gives a Mütek charge higher than 0 μeq/g to the aqueous suspensions of PCC produced.

According to another embodiment, the aqueous suspensions of PCC obtained with the use of the cationic polymer are characterized in that they present a Mütek charge higher than 0 μeq/g, for example between 0 μeq/g and +8 μeq/g.

According to the present invention, the at least one polymer defined above is added during step i) of the method for producing PCC, i.e. the polymer is added before or during the slaking step. As known to the skilled person, the milk of lime obtained by slaking of a calcium oxide containing material with water has usually a pH between 11 and 12.5 at a temperature of 25° C., depending on the concentration of the calcium oxide containing material in the milk of lime. Since the slaking reaction is exothermic, the temperature of the milk of lime typically reaches a temperature between 80° C. and 99° C. According to one embodiment of the present invention, the at least one polymer of the use according to the invention is chosen such that it is stable in an aqueous suspension with a pH of 12 and a temperature of 95° C. In the meaning of the present invention, “stable in an aqueous suspension with a pH of 12 and a temperature of 95° C.” means that the polymer maintains its physical properties and chemical structure when added to an aqueous suspension with a pH of 12 and a temperature of 95° C. For example, the polymer maintains its dispersing qualities and is not depolymerized or degraded under said conditions. The absence of any depolymerization or degradation of the polymer may be determined by measuring the amount of tree monomers in the milk of lime and/or the obtained aqueous suspension of PCC. According to one embodiment of the present invention, the amount of free monomers in the milk of lime is lower than 0.1 wt.-%, preferably lower than 0.05 wt.-%, more preferably lower than 0.01 wt-% and most preferably lower than 0.005 wt.-% relative to the total amount of the at least one polymer provided in step i).

According to one embodiment of the present invention, the at least one cationic polymer used in step i) of the method consists of one type of polymer only. Alternatively, the at least one polymer of step i) may consist of a mixture of at least two types of polymers. According to one embodiment of the present invention, the at least one cationic polymer is added in an amount from 0.01 wt.-% to 0.5 wt.-%, preferably from 0.02 wt.-% to 0.4 wt.-% and more preferably from 0.05 wt.-% to 0.35 wt.-% relative to the total weight of the calcium oxide containing material.

The at least one cationic polymer may be provided in the form of a solution or as a dry material. According to one embodiment, the at least one cationic polymer of step i) is provided in the form of an aqueous solution with a polymer concentration from 1 wt.-% to 70 wt.-% and preferably from 2 wt.-% to 60 wt.-% relative to the total weight of the aqueous solution.

The cationic polymers of the present invention are obtained through known radical polymerization methods in solutions, in direct or invert emulsions, in suspensions or through precipitation in appropriate solvents, in the presence of known catalyst systems and transfer agents or through mediated radical polymerization methods, preferentially through nitroxide-mediated polymerization (NMP) or cobaloxyme-mediated polymerization, atom transfer radical polymerization (ATRP) or sulfur derivative-mediated radical polymerization, said sulfur derivatives being chosen from among carbamates, dithioesters or trithiocarbonates (RAFT) or xanthates.

Slaking Additive

In step i) of the method for producing PCC, at least one slaking additive may be used in addition to the cationic polymer.

In this case, according to one embodiment, the preparation of the milk of lime according to step i) additionally consists in mixing at least one slaking additive.

The at least one slaking additive may be chosen from the group consisting of organic acids, organic acid salts, sugar alcohols, monosaccharides, disaccharides, polysaccharides, gluconates, phosphonates, lignosulfonates and mixtures thereof.

According to one embodiment of the present invention, the at least one slaking additive is chosen from the group consisting of sodium citrate, potassium citrate, calcium citrate, magnesium citrate, monosaccharides, disaccharides, polysaccharides, sucrose, sugar alcohols, meritol, citric acid, sorbitol, sodium salt of diethylene triamine pentaacetic acid, gluconates, phosphonates, sodium tartrate, sodium lignosulfonate, calcium lignosulfonate and mixtures thereof. According to a preferred embodiment, the at least one slaking additive is sodium citrate and-or saccharose.

According to one embodiment of the present invention, the at least one slaking additive of step i) consists of one type of slaking additive only. Alternatively, the at least one slaking additive of step i) may consist of a mixture of at least two types of slaking additives.

The at least one slaking additive may be added in an amount from 0.01 wt.-% to 2 wt.-% relative to the total amount of calcium oxide containing material, preferably in an amount from 0.05 wt.-% to 1 wt.-%, more preferably from 0.06 wt.-% to 0.8 wt.-% and most preferably from 0.07 wt.-% to 0.5 wt-%.

The addition of a slaking additive may be useful to control the size of the PCC particles and their crystalline morphology without affecting the viscosity of the aqueous suspension.

Method Step i)

In step i) of the method for producing PCC, a milk of lime is prepared by mixing water, the calcium oxide containing material, the at least one cationic polymer and optionally the at least one slaking additive.

According to the invention, in step i), the calcium oxide containing material and water are mixed in a weight ratio from 1:1 to 1:6. In a preferred manner, the calcium oxide containing material and water are mixed in step i) in a weight ratio from 1:2.5 to 1:4.

According to one embodiment, the calcium oxide containing material and water are mixed in step i) in a weight ratio from 1:2.5 to 1:6.

The reaction of the calcium oxide containing material with water results in the formation of a milky calcium hydroxide suspension, better known as milk of lime. Said reaction is highly exothermic and is also designated as “lime slaking” in the art.

According to one embodiment of the present invention the temperature of water, which is used in mixing step i), i.e. the temperature of water which is used to slake the calcium oxide containing material, is adjusted to be in the range from 0° C. to 100° C., for example from 1° C. to 70° C. or from 2° C. to 50° C. or from 30° C. to 50° C. or from 35° C. to 45° C. It will be apparent to the person skilled in the art that the initial temperature of water is not necessarily the same one as the temperature of the mixture prepared in step i) due to the highly exothermic character of the slaking reaction and/or due to the mixing of substances with different temperatures.

According to one embodiment of the present invention, method step i) comprises the steps consisting in:
a1) mixing the at least one cationic polymer with water, optionally the at least one slaking additive and
a2) adding the calcium oxide containing material to the mixture of step a1).

According to one embodiment, step a1) is carried out at a temperature between 0° C. and 99° C., for example between 1° C. and 70° C. or between 2° C. and 50° C. or between 30° C. and 50° C. or between 35° C. and 45° C.

According to another embodiment of the present invention, method step i) comprises the steps consisting in:
b1) mixing the calcium oxide containing material, the at least one cationic polymer, and optionally the at least one slaking additive and
b2) adding water to the mixture of step b1).

According to still another embodiment of the present invention, in method step i) the calcium oxide containing material, the at least one polymer, optionally the at least one slaking additive, and water are mixed simultaneously.

According to still another embodiment of the present invention, the at least one slaking additive is added before or after step i) of the method.

The at least one polymer may be added in step i) in one portion or in several portions. According to one embodiment, in step i), the at least one cationic polymer is mixed with water, the calcium oxide containing material and the at least one slaking additive by adding the at least one cationic polymer in one portion or in two, three, four five or more portions.

Method step i) may be carried out at room temperature, i.e. at a temperature of 20° C.±2° C., or at an initial temperature between 30° C. and 50° C. or between 35° C. and 45° C. Since the reaction is exothermic, the temperature typically reaches a temperature between 85° C. and 99° C. during step i), preferably a temperature between 90° C. and 95° C. According to one preferred embodiment, method step i) is carried out by mixing or stirring, for example under mechanical stirring. Suitable method equipment for mixing or stirring is known to the person skilled in the art.

The progress of the slaking reaction mas be observed by measuring the temperature and/or conductivity of the reaction mixture. It may also be monitored by turbidity control. Alternatively or additionally, the progress of the slaking reaction may be inspected visually.

The inventors surprisingly found that the addition of a cationic polymer as defined above and optionally a slaking additive as defined above, before or during the slaking step of a method for producing PCC may allow the preparation of a milk of lime not only with a low dry solids content but also with a high dry solids content. It is indeed interesting to note that, according to one aspect, of the invention, by carbonating said highly concentrated milk of lime, an aqueous suspension of PCC may be obtained which has also a high dry solids content. As a result, the method of the present invention does not require any additional concentration step in order to obtain a PCC suspension with a high dry solids content.

According to the present invention, the calcium oxide containing material and water are mixed in a weight ratio from 1:1 to 1:6, for example from 1:2.5 to 1:6 or from 1:2.5 to 1:4. According to one preferred embodiment, in step i), the calcium oxide containing material and water are mixed in a weight ratio front 1:3 to 1:5.

According to one embodiment of the present invention, the milk of lime of step i) has a dry solids content of at least 15 wt.-%, preferably from 15 wt.-% to 45wt.-%, more preferably from 20 wt.-% to 40 wt.-% and most preferably from 25 wt.-% to 37 wt.-% relative to the total weight of the milk of lime.

According to one embodiment of the present invention, the milk of lime of step i) has a Brookfield viscosity from 1 mPa·s to 1,000 mPa·s at 25° C., more preferably from 5 mPa·s to 800 mPa·s at 25° C. and most preferably from 10 mPa·s to 500 mPa·s at 25° C.

According to one embodiment, the Brookfield viscosity is measured at 100 rpm.

In the context of the present invention, additional water may be introduced during the slaking reaction in order to control and/or maintain and/or achieve the desired dry solids content or Brookfield viscosity of the milk of lime.

Method step i) may be carried out in the form of a batch, semi-continuous or continuous method.

Method Step ii)

In step ii) of the method for producing PCC, the milk of lime obtained from step i) is carbonated to form an aqueous suspension of precipitated calcium carbonate.

The carbonation is carried out by means and under conditions well-known by the person skilled in the art. The introduction of carbon dioxide into the milk of lime quickly increases the carbonate ion (CO₃²⁻) concentration and calcium carbonate is formed. Particularly, the carbonation reaction may be readily controlled considering the reactions involved in the carbonation method. Carbon dioxide dissolves according to its partial pressure forming carbonate ions via the formation of carbonic acid (H₂CO₃) and hydrogen carbonate ions (HCO₃⁻) being unstable in alkaline solution. Upon continued dissolution of carbon dioxide, hydroxide ions are consumed and the concentration of carbonate ions increases until the concentration of dissolved calcium carbonate exceeds the solubility product and solid calcium carbonate precipitates.

According to one embodiment of the present invention, in step ii), the carbonation is carried out by incorporating pure gaseous carbon dioxide or technical gases containing at least 10 vol.-% of carbon dioxide in the milk of lime.

The progress of the carbonation reaction may be readily observed by measuring the conductivity, turbidity and/or pH. In this respect, the pH of the milk of lime before addition of carbon dioxide will be higher than 10, usually between 11 and 12.5 and will constantly decrease until a pH of about 7 is reached. At this point the reaction may be stopped.

Conductivity slowly decreases during the carbonation reaction and rapidly decreases to low levels, when the precipitation is completed. The progress of the carbonation may be monitored by measuring the pH and/or the conductivity of the reaction mixture.

According to one embodiment of the method for producing PCC, the temperature of the milk of lime obtained from step i), which is used in step ii), is adjusted to be in the range from 20° C. to 60° C. and preferably from 30° C. to 50° C. It will be apparent to the person skilled in the art that the initial temperature of the milk of lime is not necessarily the same one as the temperature of the mixture prepared in step ii) due to the exothermic carbonation reaction character and/or due to the mixing of substances with different temperatures.

According to one embodiment of the method for producing PCC, step ii) is carried out at a temperature between 5° C. and 95° C., preferably from 30° C. to 70° C. and more preferably from 40° C. to 60° C.

Method step ii) may be carried out in the form of a batch, semi-continuous or continuous method. According to one embodiment, the method for producing PCC involving the method steps i) and ii) is carried out in form of a batch, semi-continuous or continuous method.

According to one embodiment of the present invention, the method for producing PCC does not comprise any step of concentrating of the aqueous suspension of precipitated calcium carbonate obtained from steps i) to ii) of the method.

As already mentioned above, the inventors surprisingly found that the addition of a cationic polymer as defined above optionally in combination with the addition of a slaking additive before or during the slaking step of a method for producing PCC may allow the preparation of a PCC suspension with a high dry solids content. It is also believed that the omission of a concentration step improves the quality of the produced PCC particles, since surface damages of the particles, which may occur during the concentration step, are avoided. It was also found that said PCC suspension may be further concentrated to a solids content of 52 wt.-% at acceptable viscosities, for example Brookfield viscosities of less than or equal to 1,000 mPa·s at 25° C. and 100 rpm.

Generally, this may not be done with PCC suspensions that are obtained by conventional PCC production methods comprising a concentrating step because the viscosity of said suspension would reach a non-pumpable range.

According to one embodiment of the method for producing PCC, the obtained precipitated calcium carbonate has a weight average particle size d₅₀ from 0.1 μm to 100 μm, preferably from 0.25 μm to 50 μm, more preferably from 0.3 μm to 5.0 μm and most preferably from 0.4 μm to 3.0 μm.

The precipitated calcium carbonate may have aragonite, calcite or vaterite crystalline structure or mixtures thereof. Another advantage of the present invention is that the crystalline structure and morphology of the precipitated calcium carbonate may be controlled, for example by addition of seed crystals or other structure modifying chemical products. According to one preferred embodiment, the precipitated calcium carbonate obtained by the method of the invention has a clustered scalenohedral crystalline structure.

The BET specific surface area of the precipitated calcium carbonate obtained by the method according to the present invention may be from 1 m²/g to 100 m²/g, preferably from 2 m²/g to 70 m²/g, more preferably from 3 m²/g to 50 m²/g, especially from 4 m²/g to 30 m²/g, measured using nitrogen and the BET method according to ISO 9277 standard. The BET specific surface area of the precipitated calcium carbonate obtained by the method of the present invention may be controlled by the use of additives, for example surface active agents, which involve shearing during the precipitation step or thereafter at high mechanical shearing rates not only leading to a low particle size, but also to a high BET specific surface area.

According to one embodiment of the present invention, the obtained suspension of precipitated calcium carbonate has a dry solids content of at least 10 wt.-%, preferably from 20 wt.-% to 50 wt.-%, more preferably from 25 wt.-% to 45 wt.-% and most preferably from 30 wt.-% to 40 wt.-% relative to the total weight of the suspension.

According to one embodiment of the present invention, the suspension of PCC of step ii) has a Brookfield viscosity of less than or equal to 1,000 mPa·s at 25° C., more preferably less than or equal to 800 mPa·s at 25° C. and most preferably less than or equal to 600 mPa·s at 25° C. The Brookfield viscosity may be measured at 100 rpm.

Another aspect of the present invention relates to the use of a combination of at least one water-soluble polymer and one slaking additive in a method for producing an aqueous suspension of precipitated calcium carbonate, in which:
the at least one cationic polymer at least consists of monomer units with a net positive charge, for example monomer units with a quaternary amine and making it possible to produce a PCC suspension with a Zeta potential greater than 0 mV and
the slaking additive is chosen from the group consisting of organic acids, organic acid salts, sugar alcohols, monosaccharides, disaccharides, polysaccharides, gluconates, phosphonates, lignosulfonates and mixtures thereof.

Additional Steps of the Method

The method of the present invention may comprise additional steps.

The milk of lime may be screened in order to remove oversize particles. A suitable sieve may comprise, for example, a sieve with a sieve size from 700 μm to 100 μm, for example about 100 μm or about 300 μm. According to one embodiment of the present invention, the milk of lime is screened after step i) and before step ii), preferably with a sieve with a sieve size from 100 μm to 300 μm.

The method for producing precipitated calcium carbonate may further comprise a step iii) of separating the precipitated calcium carbonate from the aqueous suspension obtained from step ii).

For the purposes of the present invention, the expression “separating” means that the PCC is removed or isolated from the aqueous suspension obtained from step ii) of the method. Any conventional means of separation known to the person skilled in the art may be used, for example mechanically and/or thermally. Examples of mechanical separation methods are filtration, for example by means of a drum filter or filter press, nanofiltration or centrifugation. An example of a thermal separation method is a concentration method by the application of heat, for example in an evaporator.

The obtained PCC may be transformed, for example, deagglomerated or subjected to a dry grinding step. It may also be wet ground in the form of a suspension. If the PCC is subjected to dewatering. dispersion and/or grinding steps, these steps may be accomplished by procedures known in the art. Wet grinding may be carried out in the absence or in the presence of a grinding aid agent. Dispersants may also be included to prepare dispersions if desired.

The method for producing precipitated calcium carbonate may further comprise a step iv) of drying the separated precipitated calcium carbonate obtained from step iii).

In general, the drying step iv) may be carried out using any suitable drying equipment and may, for example, comprise a thermal drying and/or a drying at reduced pressure using an equipment such as an evaporator, a flash drier, an oven, a spray drier and/or drying in a vacuum chamber.

Drying step iv) leads to a dry precipitated calcium carbonate with a low total moisture content which is less than or equal to 1.0 wt.-% relative to the total weight of the dry precipitated calcium carbonate.

The precipitated calcium carbonate obtained by the method of the invention may be post-treated, for example during and/or after a drying step with an additional component.

According to one embodiment, the precipitated calcium carbonate is treated with a fatty acid, for example stearic acid, a silane or phosphoric esters of fatty acids.

Finally, the invention also relates to the use of at least one cationic polymer in a method for producing an aqueous suspension of precipitated calcium carbonate obtained according to the invention.

### EXAMPLES

1. Measurement Methods

In the following, measurement methods used in the examples are described.

Brookfield Viscosity

The Brookfield viscosity was measured after one hour of production and after one minute of stirring at 25° C.±1° C. at 100 rpm using an RVT type Brookfieid viscometer equipped with an appropriate disc spindle, for example a spindle 2 to 5.

pH Measurement

The pH of a suspension or solution was measured at 25° C. using a Mettler Toledo Seven Easy pH meter and a Mettler Toledo InLab® Expert Pro pH electrode. A three-point calibration (according to the segmentation method) of the instrument was first made using commercially available buffer solutions having pH values of 4, 7 and 10 at 20° C. (from Sigma-Aldrich Corp., USA). The reported pH values are the endpoint values detected by the instrument (the endpoint was when the measured signal differs by less than 0.1 mV from the average over the last 6 seconds).

Particle Size Distribution

The particle size distribution of the prepared PCC particles was measured using a Sedigraph 5100 apparatus from the company Micromeritics, USA. The method and the instrument are known to the person skilled in the art and are commonly used to determine grain size of mineral fillers and pigments. The measurement was carried out in an aqueous solution comprising 0.1 wt.-% of Na₄P₂O₇. The samples were dispersed using a high speed stirrer and ultrasound. For the measurement of dispersed samples, no other dispersing agent was added.

Dry Solids Content of an Aqueous Suspension

The suspension dry solids content (also known as “dry weight”) was determined using a Moisture Analyser MJ33 from the company Mettler-Toledo, Switzerland, with the following settings: drying temperature of 160° C., automatic switch off if the mass does not change by more than 1 mg over a period of 30 sec, standard drying of 5 g to 20 g of suspension.

Specific Surface Area (SSA)

The specific surface area was measured via the BET method according to ISO 9277 standard using nitrogen, followed by conditioning of the sample by heating at 250° C. for a period of 30 minutes. Prior to such measurements, the sample is filtered within a Büchner funnel, rinsed with deionised water and dried overnight at a temperature between 90° C. and 100° C. in an oven. Subsequently the dry filtration cake is ground thoroughly in a mortar and the resulting powder is placed in a moisture analysis balance at 130° C. until a constant weight is reached.

Specific Carbonation Time

The monitoring of the conductivity, which slowly decreases during the carbonation reaction and rapidly decreases to a minimal level, thereby indicating the end of the reaction, was used to assess the time needed to perform the complete precipitation. The specific carbonation time (min/kg of Ca(OH)₂) was determined by the following formula:

$$Specific carbonation time = \frac{{10}^{5} \cdot Tf}{M \cdot {SC}_{MoL}}$$

in which;
Tf (mm) is the time needed to complete the carbonation of the milk of lime, as determined by monitoring the conductivity,
M (g) is the weight of the milk of lime introduced into the carbonation reactor and
SC_{Mol.} (%) is the weight dry solids content of the milk of lime.

Specific Viscosity of the Polymer

The term “specific viscosity” in the meaning of the present invention is defined as the difference of the relative viscosity as measured at a given temperature minus 1.

ηₓₚ=ηᵣₑₗ−1

The relative viscosity as used herein is the quotient of the solution viscosity η and the solvent viscosity η₀.

$${η}_{rel} = \frac{η}{{η}_{0}}$$

where the solvent viscosity η₀ is defined as the viscosity of the pure solvent at a given temperature (for example 20° C. or 25° C.) and the solution viscosity η is defined as the viscosity of the polymer dissolved in the pure solvent at a given temperature and at a given polymer concentration (for example 50 g/L).

However, to determine the relative viscosity it is sufficient to measure the elation time t (of the polymer solution) and to (of the solvent) at a given temperature (for example 20° C. or 25° C.) if the boundary conditions are constant. Therefore, the relative viscosity may be defined as:

$${η}_{rel} = \frac{t}{{t}_{0}}$$

and, thus, the specific viscosity may be defined as:

$${η}_{sp} = \frac{t}{{t}_{0}} - 1$$

More precisely, the specific viscosity of the polymer was obtained from an aqueous polymer solution with a polymer concentration of 50 g/L in a NaCl solution (120 g/L), the pH of the polymer solution being possibly adjusted with ammonia to be within the range from 6 to 7. The elution times t and t₀ were measured at 25° C.±0.2° C., using a viscosimetric tube USA KIMAX (reference: size 100 nº46460 B2).

t₀: In order to determine t₀, an aqueous NaCl solution was prepared by using reverse osmosis water, the NaCl solution with a concentration of 120 g/L.

t: In order to determine t, 2.5 g of the dry polymer was combined with 50 g of reverse osmosis water and 6 g of NaCl in order to obtain a homogenous solution.

The elution times t and t₀ were measured at 25° C.±0.2° C. and ηₛₚ was calculated according to the above-mentioned formulae.

Charge Measurement—Mütek

The charge measurement was carried out using a Mütek PCD 03 device equipped with a Mütek PCD titrator.

0.5 g to 1 g of dry PCC is weighed in the plastic measuring cell and is diluted with 20 mL of deionised water. Put the displacement piston on. While the piston oscillates in the cell, wait until the streaming current between the two electrodes stabilize.

The sign of the measured value shown on the display indicates whether the charge of the sample is positive (cationic) or negative (anionic). An oppositely charged polyelectrolyte of known charge density is added to the sample as a titrant (either sodium polyoxyethylene sulfate 0.001 N or pDADMAC 0.001 N). The titrant charges neutralize existing charges of the sample. Titration is discontinued as soon as the point of zero charge (0 mV) is reached.

Titrant consumption in mL forms the basis for further calculations. The specific charge amount q [eq/g of slurry] is calculated according to the following formula:

q=(V*c)/m
V: consumed titrant volume [L]
c: titrant concentration [eq/L] or [μeq/L]
m: mass of the weighed slurry [g]
q: specific charge amount [eq/g of slurry] or [μeq/g of slurry]

Zeta Potential

For measuring the Zeta potential, a few drops of the PCC suspension are dispersed in a sufficient amount of serum obtained by mechanical filtration of said suspension in order to obtain a colloidal suspension which is slightly cloudy.

This suspension is introduced into the measuring, cell of the Zetasizer Nano-ZS apparatus from Malvern, which directly displays the value of the Zeta potential of the PCC suspension in mV.

### 2. Example

A milk of lime was prepared by mixing under mechanical stirring water with cationic polymers P1 to P5 (if available) and/or a shaking additive (for example dry sodium citrate, NaCi) (if available), at an initial temperature between 50° C. and 51° C. (the amounts of slaking additives and polymers are indicated in Table 2 below). Subsequently, calcium oxide (quicklime raw material from Golling, Austria) was added. The obtained mixture was stirred for 25 min and then screened through a 200 μm sieve. The obtained milk of lime was transferred into a stainless steel reactor, in which the milk of lime was cooled down to 50° C. Then the milk of lime was carbonated by introducing an air/CO₂ mixture (26 vol.-% CO₂), flow rate of 23 min/L. During the carbonation step, the reaction mixture was stirred with a speed of 1,400 rpm. The kinetics of the reaction were monitored by online pH and conductivity measurements.

Polymer additives exemplified:

P1=MADQUAT (according to the invention)

Specific viscosity: 2.66

P2=70% Madquat/30% Maptac (according to the invention)

Specific viscosity: 2.19

P3=70% Madquat/30% Maptac (according to the invention)

Specific viscosity; 1.68

P4=50% Madquat/50% acrylic acid (according to the invention)

Specific viscosity: 2.87

P5=pDADMAC (according to the invention)

Specific viscosity: 9.98

P6=sodium polyacrylate (outside the invention)−Mw=4,270 g/mol, PDI=2.3 (Mw and PDI determined according to unpublished patent application EP 14166751.9).

TABLE 1
Characteristics of the prepared milks of lime (INV: according
to the INVention - OI: Outside the Invention)

| | | | | | | Solids |
|---|---|---|---|---|---|---|
| | | | Cationic | | Slaking | Content |
| | | | polymer | | additive | Milk of |
| | | Polymer | amount | Slaking | amount | Lime |
| | | additive | [wt.-% CaO] | additive | [wt.-% CaO] | [wt.-%] |
| 1 | OI | no | — | NaCi | 0.1 | 25.2 |
| 2 | OI | no | — | NaCi | 0.1 | 15.7 |
| 3 | INV | P1 | 0.15 | NaCi | 0.1 | 25.2 |
| 4 | INV | P2 | 0.15 | NaCi | 0.1 | 25.0 |
| 5 | INV | P3 | 0.15 | NaCi | 0.1 | 24.9 |
| 6 | INV | P4 | 0.15 | NaCi | 0.1 | 25.5 |
| 7 | INV | P5 | 0.15 | NaCi | 0.1 | 25.5 |
| 8 | OI | P6 | 0.15 | NaCi | 0.1 | 29.9 |
| 9 | INV | P1 | 1 | NaCi | 0.1 | 23.3 |

The characteristics of the prepared milks of lime and aqueous PCC suspensions are described in Table 2 below.

TABLE 2
Characteristics of the PCC suspensions (INV: according
to the INVention - OI: Outside the Invention)

| | | Viscosity | | Viscosity | | | | |
|---|---|---|---|---|---|---|---|---|
| | | of the | | of the | | | | |
| | Solids | milk of lime | | S-PCC | | | | |
| | Content | (mPa · s) | Carbonation | (mPa · s) | Zeta | | | |
| | S-PCC | at 100 | time (min/kg | at 100 | potential | Mutek | D50 | SSA |
| Tests | [wt.-%] | rpm | Ca(OH)₂) | rpm | (mV) | (μeq/g) | (μm) | (m²/g) |
| 1 OI | Too high viscosity - | | | — | — | — | — | — |
| | not manageable | | | | | | | |
| 2 OI | 20.2 | 20 | 52 | 20 | +4.9 | −0.2 | 1.5 | 4.7 |
| 3 INV | 31.2 | 204 | 53 | 202 | +0.1 | +2.3 | 1.9 | 4.7 |
| 4 INV | 32.1 | 83 | 46 | 225 | +8.8 | −3.2 | 1.4 | 5.2 |
| 5 INV | 32.3 | 74 | 46 | 175 | +0.2 | −0.1 | 1.4 | 6.3 |
| 6 INV | 32.6 | 64 | 45 | 994 | +0.2 | −0.6 | 1.5 | 5.0 |
| 7 INV | 33.6 | 164 | 47 | 1380 | +30.5 | +2.2 | 1.4 | 4.9 |
| 8 OI | 37.2 | 294 | 46 | 573 | −10.5 | −0.9 | 1.3 | 5.0 |
| 9 INV | 29.8 | 441 | 46 | 191 | +5.9 | +5.9 | 1.5 | 5.9 |

The results compiled in Table 2 show that the use of a slaking additive alone leads to a milk of lime with a high Brookfield viscosity (sample 1) and that it is not possible to increase the solids content of the milk of lime (wt.-%) while at the same time preventing increases of the slurry viscosity (comparison of sample 1 and sample 2).

In contrast, samples 3 to 7 and 9 of the invention confirm that the viscosity of the obtained milk of lime and PCC suspension is totally in line with the intended use of the PCC so obtained that is to say suspensions of PCC with a Brookfield viscosity of less than or equal to 1,500 mPa·s at 25° C., more preferably less than or equal to 1,000 mPa·s at 25° C. for samples 3 to 6 and 9 and most preferably less than or equal to 600 mPa·s at 25% for samples 3 to 5 and 9.

Additionally, the kinetics of carbonation and the crystallographic structure of the prepared PCC (results not shown) are similar to the ones obtained with a method involving the use of an anionic polymer (P6 polymer outside the invention, for comparison only).

1. A method for producing an aqueous suspension of precipitated calcium carbonate, the method comprising:
i) preparing a milk of line by mixing a mixture comprising water, a calcium oxide containing material and at least one cationic polymer, wherein the calcium oxide containing material and water are mixed in a weight ration of from 1:1 to 1:6 and
ii) carbonating the obtained milk of lime to form the aqueous suspension of precipitated calcium carbonate.

2. The method according to claim 1, wherein the at least one cationic polymer comprises monomer units with a net positive charge.

3. The method according to claim 1, wherein in i), the calcium oxide containing material and water are mixed in a weight ratio of from 1:2.5 to 1:6 or from 1:2.5 to 1:4.

4. The method according to claim 1, wherein the mixture in i) further comprises at least one slaking additive.

5. The method according to claim 4, wherein the at least one slaking additive is selected from the group consisting of sodium citrate, potassium citrate, calcium citrate, magnesium citrate, a monosaccharide, a disaccharide, a polysaccharide, sucrose, a sugar alcohol, meritol, citric acid, sorbitol, a sodium salt of diethylene triamine pentaacetic acid, a gluconate, a phosphonate, sodium tartrate, sodium lignosulfonate, calcium lignosulfonate, and a mixture thereof.

6. The method according to claim 1, wherein the obtained milk of lime in i) has a Brookfield viscosity from 1 mPa·s to 1,000 mPa·s at 25° C., at 100 rpm.

7. The method according to claim 1, wherein the suspension of precipitated calcium carbonate obtained in ii) has a Brookfield viscosity of less than or equal to 1,000 mPa·s at 25° C., at 100 rpm.

8. The method according to claim 1, wherein the obtained suspension of precipitated calcium carbonate has a dry solids content of at least 10 wt.-% relative to a total weight of the suspension.

9. The method according to claim 4, wherein the at least one slaking additive is added in an amount from 0.01 wt.-% to 2 wt.-% relative to a total amount of the calcium oxide containing material.

10. The method according to claim 1, wherein a temperature of water in i) is from 0° C. to 100° C.

11. The method according to claim 1, wherein a temperature of the obtained milk of lime is from 20° C. to 60° C.

12. (canceled)
